(19) United States
(12) Patent Application Publication
(10) Pub. No.: US 2008/0104199 A1
(43) Pub. Date: May 1, 2008

(54) Identity and preference management via universal identifier

(75) Inventor: Chris Kalaboukis, Los Gatos, CA (US)

Correspondence Address: BRINKS HOFER GILSON & LIONE / YAHOO! OVERTURE, P.O. BOX 10395, CHICAGO, IL, 60610, US

(73) Assignee: YAHOO! INC.

(21) Appl. No.: 11/590,520

(22) Filed: Oct. 31, 2006

(51) Int. Cl. G06F 15/16

(52) U.S. Cl. 709/217

(57) ABSTRACT

A system is disclosed for utilizing a universal identifier (“ID”) that allows for access to information associated with the ID. The ID may be a substitute for a variety of information, such as contact information. When a user requests information for a given ID, an ID server may provide that information.

### TECHNICAL FIELD

The present embodiments relate to a universal identifier.

### BACKGROUND

An individual may have multiple phone numbers, postal addresses, email addresses, or other forms or methods by which they may be contacted. A third party desiring to contact an individual using a particular method must record or remember the particular contact data in order to be able to utilize that form of contact to communicate with the individual. Likewise, online businesses, which collect various forms of contact data in the course of conducting transaction, may record additional data about an individual consumer including past purchases, preferences, or payment information. Accurate records may or may not be maintained at the business to further facilitate future transactions as the amount of such information related to a user or a consumer is continually increasing. Accordingly, it may be beneficial to simplify the process of storing or accessing certain information related to a user or consumer.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

FIG. 1 provides a simplified view of one embodiment of an operating environment;

FIG. 2 is a diagram of an exemplary identifier;

FIG. 3 is a flow chart of an exemplary method for using a universal identifier;

FIG. 4 is a diagram of an embodiment illustrating an exemplary use of an identifier;

FIG. 5 is a diagram of an embodiment illustrating an exemplary use of an identifier;

FIG. 6 is a diagram of another embodiment illustrating an exemplary use of an identifier;

FIG. 7 is a diagram of another embodiment illustrating an exemplary use of an identifier;

FIG. 8 is a diagram of another embodiment illustrating an exemplary use of an identifier; and

FIG. 9 is an illustration a general computer system for use with the disclosed embodiments.

### DETAILED DESCRIPTION

The principles described herein may be embodied in many different forms. The embodiments relate to a system and method for utilizing a universal identification or universal identifier (“ID”). This system and method may simplify access to information associated with the ID.

By way of introduction, the embodiments described below include a system and method for establishing and utilizing a universal identifier (“ID”) associated with a user. The ID may be used by a third party to retrieve information related to the user of the ID. Identifying the user by only the ID simplifies the process of retrieving information associated with the user and does not require a third party to remember any of the information that may be retrieved. The ID acts as a substitute for remembering a user's information, including contact information, preferences, profile information, or payment information. That information may be retrieved based on knowing the user's ID assuming the user has granted access to the information.

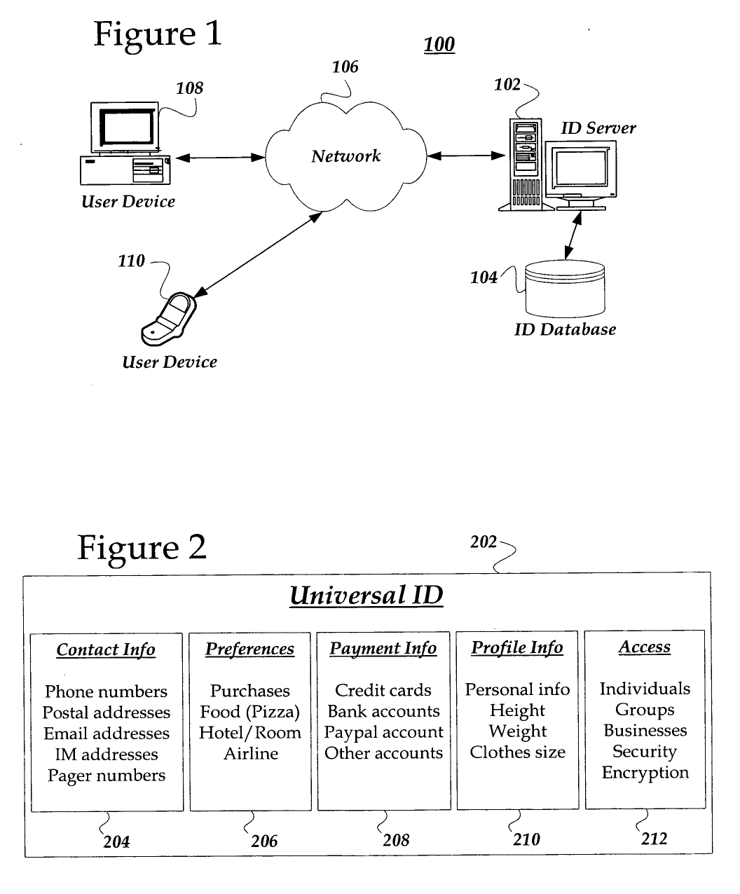

FIG. 1 provides a simplified view of one embodiment of an operating environment 100 in which the disclosed universal identifier may be utilized. Not all of the depicted components may be required and some embodiments may include additional components not shown in the figure. Variations in the arrangement and type of the components may be made without departing from the spirit or scope of the claims as set forth herein. Additional, different or fewer components may be provided. In FIG. 1, the environment 100 includes an identification (“ID”) server 102 coupled with an identification (“ID”) database 104. User devices 108, 110 are coupled with the ID server 102 through network 106. Herein, the phrase “coupled with” is defined to mean directly connected to or indirectly connected through one or more intermediate components. Such intermediate components may include both hardware and software based components.

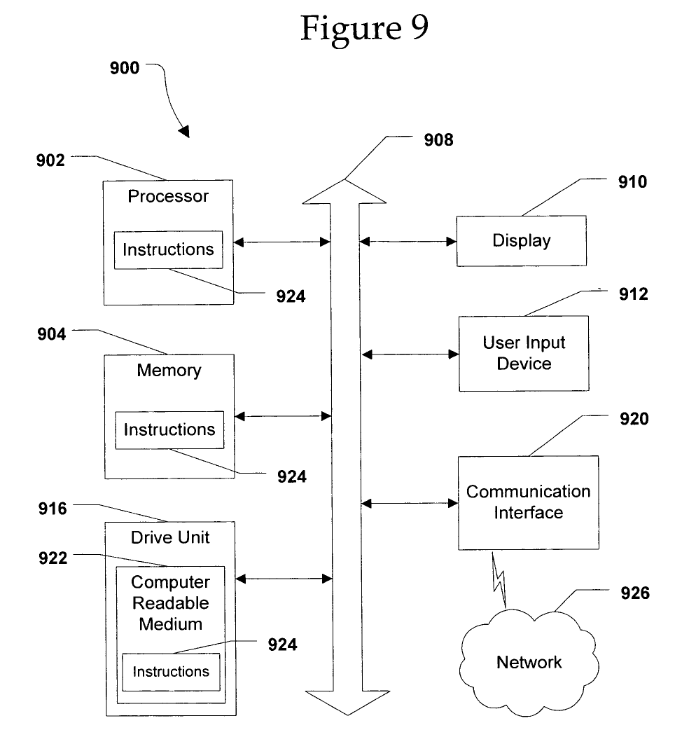

The user devices 108, 110 may represent devices in communication with the network 106 that are associated with potential users. The user devices 108, 110 may be a user input device 912 as described in FIG. 9. In one embodiment, a user may be a consumer of goods of services that is requesting information, or conducting a transaction. Alternatively, a user may include a business entity or group of people, rather than an individual person. The user devices 108, 110 may include a conventional personal computer, a mobile user device, including a network-enabled mobile phone, VoIP phone, cellular phone, personal digital assistant (PDA), pager, network-enabled television, digital video recorder, such as TIVO®, and/or automobile. Any device configured to connect with a network 106 may be user device 108 or 110. As shown, user device 108 may be a stationary user device and user device 110 may be a mobile device. In alternate embodiments, there may additional user devices, stationary and/or mobile, and additional intermediary networks that are established to connect the user devices with the ID server 102.

The network 106 may generally be enabled to employ any form of machine-comprehensible media for communicating information from one device to another and may include any communication method by which information may travel between devices. The network may be a network 926 as described in FIG. 9. For example, the network 106 may include one or more of a wireless network, a wired network, a local area network (LAN), a wide area network (WAN), a direct connection such as through a Universal Serial Bus (USB) port, and the like, and may include the set of interconnected networks that make up the Internet. The wireless network may be a cellular telephone network, a network operating according to a standardized protocol such as IEEE 802.11, 802.16, 802.20, published by the Institute of Electrical and Electronics Engineers, Inc., or WiMax network. Further, the network 106 may be a public network, such as the Internet, a private network, such as an intranet, or combinations thereof, and may utilize a variety of networking protocols now available or later developed including, but not limited to TCP/IP based networking protocols.

The coupled devices may include but are not limited to the user device 108, the user device 110, the ID server 102, and the ID database 104. In particular, ID server 102, ID database 104, and user devices 108 and 110 represent computing devices of various kinds as discussed below in FIG. 9. The network 106 may be configured to couple one computing device to another computing device to enable communication of data between the devices. Such computing devices may generally include any device that is configured to perform computation and that is capable of sending and receiving data communications by way of one or more wired and/or wireless communication interfaces, such as network 106. Such devices may be configured to communicate in accordance with any of a variety of network protocols, including but not limited to protocols within the Transmission Control Protocol/Internet Protocol (TCP/IP) protocol suite.

The ID server 102 is coupled with the network 106 allowing user devices, such as the user devices 108, 1 10 access to the ID database 104 via the ID server 102. The ID server may be a computer system or component of a computer system as described in FIG. 9. In one embodiment, the ID server 102 may act as an interface for the ID database 104, allowing users access to certain information such as the information associated with IDs as described in FIG. 2 below. In one embodiment, the ID server 102 receives requests for information associated with an ID, and/or allows the ID owner to edit any information associated with his/her ID. Alternatively, the user devices may act as an interface to the ID server 102 and/or the ID database 104.

The ID database 104 may be coupled with the ID server 102 through a network or other mechanism, such as network 106 or a direct connection. The ID server may be a computer system or component of a computer system as described in FIG. 9. In particular, the ID database 104 may be a memory that may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The ID database 104 may be an external storage device or database for storing recorded image data. Examples include a hard drive, compact disc (“CD”), digital video disc (“DVD”), memory card, memory stick, floppy disc, universal serial bus (“USB”) memory device, or any other device operative to store ID data.

The ID database 104 is configured to store ID information or data used by the ID server 102 and received from the user devices 108, 110. The ID database 104 may also transmit information associated with the ID to the user device 108 and/or the user device 110. For example, the ID database 104 may include the universal ID 202 for each user as discussed below in FIG. 2. The ID server 102 may be coupled with the ID database 104 to transmit and receive ID data to and from the ID database 104. Alternatively, the ID database 104 may be a part of the ID server 102.

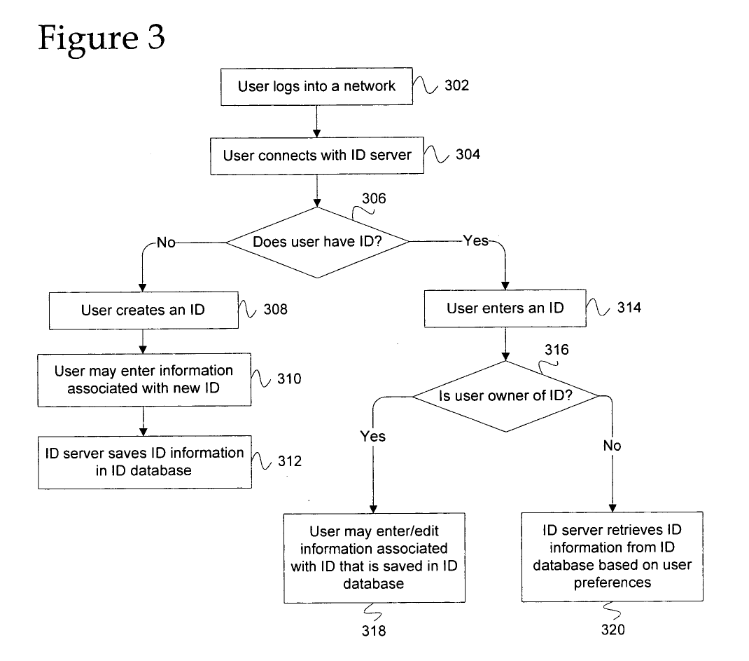

FIG. 3 is a flow chart of an exemplary method for creating or modifying an ID in the ID database 104 through the ID server 102. In block 302, a user, such as user device 108 and/or the user device 110, connects to network 106. Through the network 106, the user may connect with the ID server 102 as in block 304. The user devices 108, 110 may include an interface (not shown) with the network 106 and/or the ID server 102. In one embodiment, a website may be used to access the ID server 102 and the ID database 104 and act as an interface for retrieving ID information. Accordingly, a user may log into the website and either modify the information associated with his/her own ID or view/download the information associated with another person's ID. Accordingly, the user devices 108, 110 may include user-interactive devices that may run browser applications, and the like, to display requested pages and/or data received over a network.

In block 306 of FIG. 3, if the user does not have an ID, then the user may create an ID in block 308. The user may enter information that is associated with the new ID in block 308. In particular, contact information, preferences, payment information and profile information may be associated with the ID as discussed in FIG. 2. After the information is entered, it will be saved in the ID database 104 as in bock 312. The ID database 104 stores IDs and the information that is associated with those IDs. The information that is stored in the ID database 104 may then be retrieved through the ID server 102. If a user creates a second ID and they already have another pre-configured ID in other systems, they may authorize an ingest from other 'systems of information such as a wish list or shopping database associated with the first ID.

In block 306, if the user does have an ID or if the user has an ID of another user for which information is needed, the user enters the ID in block 314. In block 316, if the user is the owner of the ID, then that user may enter or edit information associated with the ID that is stored in the ID database 104 as in block 318. In block 316, if the user is not the owner of the ID, then the user may retrieve information associated with the ID from the ID database 104, depending on the established preferences and access rules that the ID owner has established.

Referring back to FIG. 1, user device 108 may have an ID (ID1) and the user device 110 may also have an ID (ID2). User device 108 may enter the user device's 110 ID2 into the ID server 102 in order to obtain information associated with ID2 as in block 320. Likewise, the user device 110 may enter the user device's 108 ID1 to obtain information associated with the user device as in block 320. Alternatively, the user device 108 may enter ID1 in block 314 and add/edit information associated with ID1 as in block 318. The information may include contact information, preferences, payment and profile information as discussed in FIG. 2. Additionally, the information may include access rules or restrictions, such as preventing the other device 108 from receiving access to the information associated with ID1.

FIG. 2 is a diagram of an exemplary identifier (“ID”). In particular, FIG. 2 illustrates a universal ID 202 that includes various information or data accessible by users from the ID server 102. The universal ID 202 may also be referred to as an ID. In one embodiment, the ID 202 may include contact information 204, preferences 206, payment information 208, profile info 210, and access restrictions/rules 212. Alternatively, the ID 202 may include additional or fewer categories of information that is associated with a particular ID 202.

In one embodiment, the ID 202 may include contact information 204, i.e. information that may used to communicate with an individual via various media, e.g. a phone number which can be used to call someone via a wired or wireless the telephone, an email address which can used to send someone an electronic mail message, a postal address which can be used to send someone a package or letter, or combinations thereof. Accordingly, if one knows a person's ID then they may be able to access that person's contact information 204. Contact information 204 may include but is not limited to phone numbers, postal addresses, email addresses, instant messenger (“IM”) addresses, or pager numbers. The contact information 204 may include historical data of past addresses and numbers. Further, contact information 204 may include information capable of identifying and/or locating an individual or group of individuals, such a cellular telephone number of a cellular phone likely to be carried by the individual, or information capable of identifying a physical or logical location or object that the individual has exclusive or non-exclusive access to, such as a residence or work postal address, electronic mail address, etc. For example, an ID may be associated with a user's home, work, and vacation addresses and phone numbers as well as work and home email addresses. A user or business may be able to retrieve any of the contact information of a person based on knowing the person's ID.

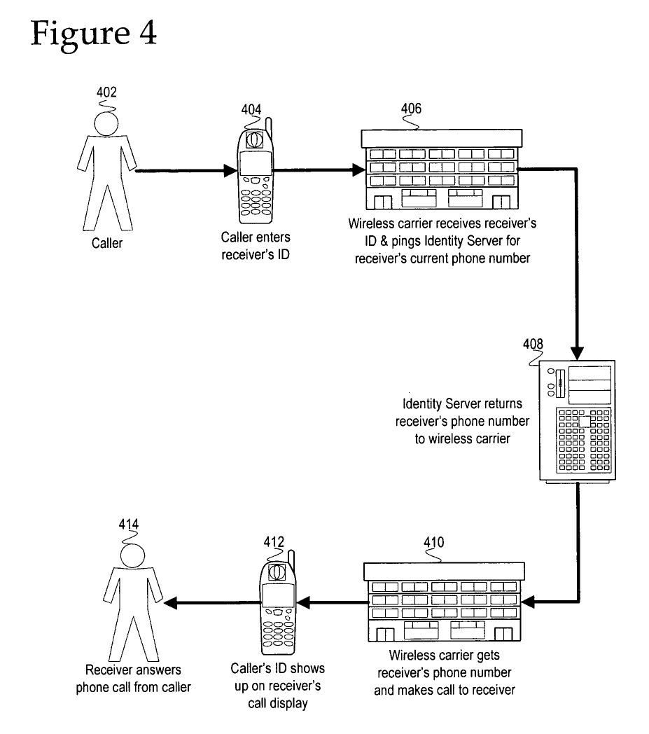

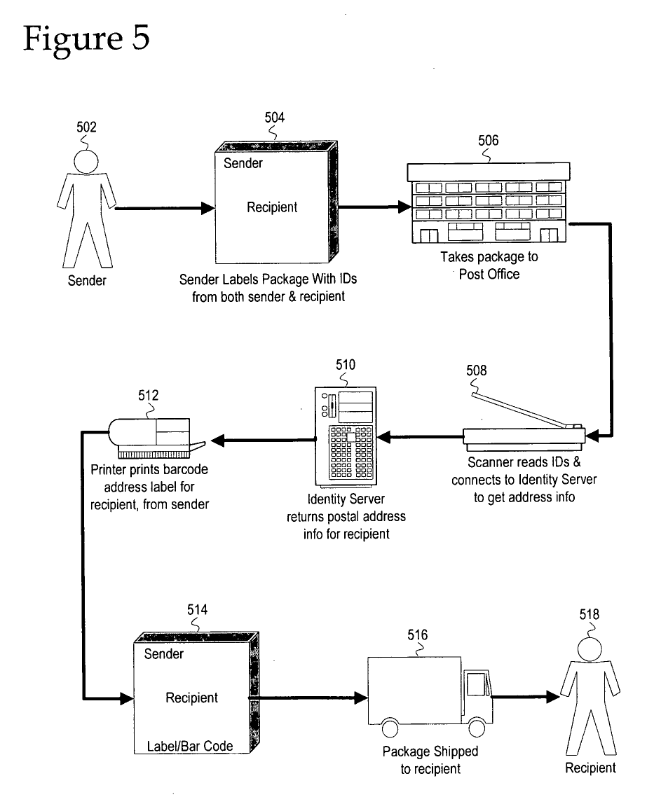

FIGS. 4 and 5 are diagrams of embodiments illustrating exemplary uses of an ID. In particular, FIG. 4 illustrates one example of retrieving a phone number using an ID and FIG. 5 illustrates one example of retrieving an address using an ID. In the exemplary scenario of FIG. 4, a caller 402 desires to make a telephone call to a receiver but does not know the receiver's telephone number. Accordingly, the caller, knowing the receiver's ID, enters that ID into a phone 404 to place the call to the receiver 414. The phone 404, being suitable programmed in accordance with the disclosed embodiments, recognizes that an ID has been entered and connects with the wireless carrier or phone company 406 and requests a call with the receiver based on the receiver's ID. The wireless carrier, also being suitable programmed in accordance with the disclosed embodiments, connects with the Identity server 408, and requests the receiver's phone number associated with the receiver's ID. The identity server 408 transmits the receiver's phone number to the wireless carrier 410/406. The wireless carrier 410 then submits a call from the caller's phone 404 to the receiver's phone 412. The caller's ID may be shown on the receiver's phone 412. The receiver 414 may then answer the call establishing the connection between the caller 402 and the receiver 414. This is one embodiment of utilizing an ID for placing a telephone call. The ID may allow user's to no longer know phone numbers, but rather just know a person's ID.

All known phone numbers may be entered for a user. The system may include a scheduling and contact preference chain that would include rules, such as “call my cell during these hours, call home during these hours, send to voice mail during these hours.” Formats may be changed based on communication preference type, for example, if a user prefers receiving instant messages, the system would take an incoming voicemail, convert it into an attachment in an instant message to the user. If an ID is unknown, then the system may allow searching of IDs based on other information, such as name. The system is searchable based on various parameters if the recipient wishes to allow themselves to be searched by any of those various parameters. System users may allow people to search the system and connect with other users via their preference set, as described in FIG. 2.

FIG. 5 illustrates one example of retrieving an address with an ID. In the exemplary scenario of FIG. 5, a sender 502 would like to mail a package to a recipient 518. The sender 502 labels the package 504 with the IDs of the recipient 518 and of the sender 502. The package is then given to the post office 506, which may translate the IDs into postal addresses. Accordingly, the package 504 is read by a scanner 508 that reads the IDs and connects with an ID server 510. The ID server 510 takes the IDs and submits postal addresses to a printer 512. The printer 512 prints a barcode address label including the postal addresses of the sender and the recipient. The label is added to the package 514 and is then ready for delivery. The package may be shipped 516 to the recipient 518 based on the address label that includes the recipient's address. This is one embodiment of utilizing an ID for retrieving a postal address. The ID may also allow a user to mail items based on only knowing an ID for the recipient, rather than knowing the address for the recipient.

In one embodiment, the ID 202 may include preferences 206. Preferences 206 may include information relating to past purchases. Other preferences 206 may include entertainment, such as favorite TV shows, movies, books, music, video games, genres, favorite websites, or bookmarks. Communications preferences may include favorite form of communication between telephone, cell phone, email, instant messaging, or text messages. Travel preferences may include hotels, airlines, food and destinations. The system may be tied to online shopping databases to track past purchases, buying preferences and habits. Preferences 206 may also include favorite colors, styles, materials, autos, wine, beer, and/or flowers.

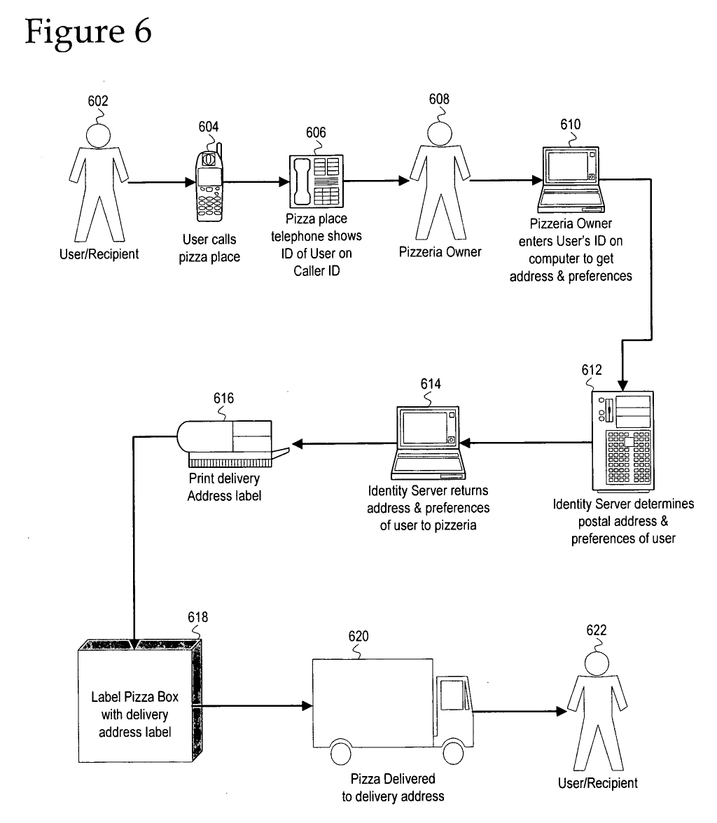

One example of past purchases may be food orders, such as pizza delivery as discussed with respect to FIG. 6. FIG. 6 is a diagram of an embodiment illustrating an exemplary use of an ID. In particular, FIG. 6 illustrates utilizing an ID to order a pizza for delivery. A user/recipient 602 uses a phone 604 to place a call to a pizza place to order a pizza to be delivered. The pizzeria phone 606 shows the ID of the user 602 placing the call. The pizzeria owner 608 may enter the user's ID in his computer 610 in order to retrieve information about the user 602 from the user's ID. The pizzeria's phone may also be connected to a network or the Internet and automatically call up the users preferences via this connection.

The pizzeria computer 610 may connect with an identity server 612 to look up information about the user. The identity server 612 may send address information and preferences back to the pizzeria owner's computer 614. The address may be the postal address for delivery of the pizza and the preferences may include the type of pizza that the user prefers. Preferences may further include any side orders, such as breadsticks or soda pop that the user commonly orders with a particular type of pizza. In addition, the user may frequently request extra cheese or thick crust that will be included in the preferences. Accordingly, the lookup of preferences and address may be automated so as soon as the pizzeria owner answers the phone, his computer screen will display the user's name, address, phone, and preferences. The pizzeria owner may then ask the user if he would like to order a medium pepperoni pizza like last time. Also, the owner knows the user's address which he can verify with the user.

Once the pizzeria computer 614 has received the relevant information, the owner 608 may verify that information with the user 602. The owner 608 checks that the address is current and receives the user's order which may or may not be the same as the user's preferences. A printer 616 prints a delivery label with the user's address. The delivery label is added to the pizza box 618 and the pizza is ready for delivery 620 to the user 622. Accordingly, FIG. 6 illustrates the use of an ID to retrieve contact information in the form of a postal address and preferences in the form of type of pizza or other items for order.

Preferences may refer to anything that the user prefers in regards to a purchase or transaction. The preference information may be stored in the ID database 104, or the business itself may store that data for future reference. Preferences may include hotels, such as a type of room. For example, if a user provides an ID for a reservation, the hotel may retrieve the user's room preferences to better serve that person. The hotel may ask the user if he/she would like “a non-smoking suite with a lake view like last time?” Likewise, airlines may also utilize an ID to retrieve preferences such as flights, seats, and meals. Accordingly, a user may call an airline and give his user ID and the airline will select the flight, seat and meal based on the user's preferences. In a call a car rental place, the rental place may know that the user prefers 4-door sedans with leather seats based on receiving the user's ID either by phone or by caller identification. Alternatively, any of the examples may involve the user logging into a website with his/her ID and by virtue of that login, the business will automatically receive the user's preferences.

The universal ID includes information that is vendor independent. Other vendors or businesses may access the same information that is associated with the ID. Accordingly, individual businesses may not need to record the information, such as preferences because that information is easily accessible through the universal ID because the information may cover a broad range that may be more relevant to certain businesses than others may. Different businesses may associate a user's preferences with that user's ID in different ways. Accordingly, the universal ID is vendor-independent and media-independent because that information that is available does not depend on the vendor or on the mode of transmission or request for information. Regardless of whom, how or when the information is requested, the same information may be returned. However, the information made available may be dependent on access restrictions as discussed below. Some vendor's may not be allowed access, therefore, vendor-independence and media-independence may be accurate for those vendors who have been granted access. Two different vendors (with granted access) may request the same information and receive the same information. A pizza place and a hotel may both request food preferences for a user and receive the same information associated with the user's ID. In this sense the type of request, source of the request, type of transmission, and available data may be uniform for a particular ID. Accordingly, a user would only need to modify information associated with the ID if there are any changes, rather than notifying a plurality of vendors of changes.

In one embodiment, the ID 202 may include payment information 208. Credit cards, bank accounts, PAYPAL accounts, other account information may be associated with a user ID. Accordingly, a user may give their user ID as a form of payment for any transaction and the ID server 104 may return a payment method. In the pizza example discussed in FIG. 6, the pizzeria may automatically retrieve a credit card based on receiving the user's ID from caller identification. The pizzeria may then ask the user if he/she would like to use the VISA card for the transaction. A user would no longer need to remember or use a credit card number or checking account number, but could instead use their ID, combined with a password or other security/encryption. The use of an ID as payment may require enhanced security to prevent fraud, such as password protection or encryption.

Security may include the ID with a password and additional information. The additional information may be a random piece of information about the user. With all the profile, preference, and other data stored, that data may be used as a verification of identity. For example, the user may need ID, password and the answer to the question “name one of your favorite TV shows.”

In one embodiment, the ID 202 may include profile information 210. The profile information 210 may include personal information such as age, height and weight, or clothes size. Other profile information 210 may include interests, body type, education level, ethnicity, salary, jobs, skills, past residences, and/or languages spoken. Medical data may also be included as profile information, such as pre-existing conditions, blood type, allergies, doctor names, and emergency contact information. If a user attempts to order clothes online with their ID, the clothes size may be automatically retrieved and the user would not need to enter that information. Profile information 210 may overlap with preferences 206 in that clothes size may be considered either. Profile information 210 may be used by businesses to further tailor to the user's needs. When a user logs onto a shopping website with their ID, the website may utilize the user's age and clothes size, in addition to the user's preferences or past purchases to tailor the displayed items to that user. In one embodiment, profile information 210 includes the same information as preferences 206.

In one embodiment, the ID 202 may include access restrictions/rules 212. The access restrictions or rules may be established by a user for his/her ID. For example, a user may prohibit anyone from accessing any information, or allow everyone to have access to certain information. Different information may have different access restrictions or security. A user may allow access to an email address to anyone, but limit access to phone numbers and postal addresses. In one embodiment the user may establish the access level of each piece of information associated with the ID.

A user may set various levels of access to various groups, companies, governments and individuals. A user may allow access to payment information for all businesses that are verified by the ID server. For example, a gregarious user may choose to leave all his contact information “open to all” so that when new people are given his ID they can immediately contact him. Other, more private individuals, may wish to leave their default settings as “closed to all” and only open those lines of communications by request. Accordingly, the private individual may manually edit his access include his family and friends by listing their IDs as able to access the individual's contact information, profile information and preferences. As discussed above, there may be a website allowing user's to log in and edit their information associated with their ID including the access restrictions.

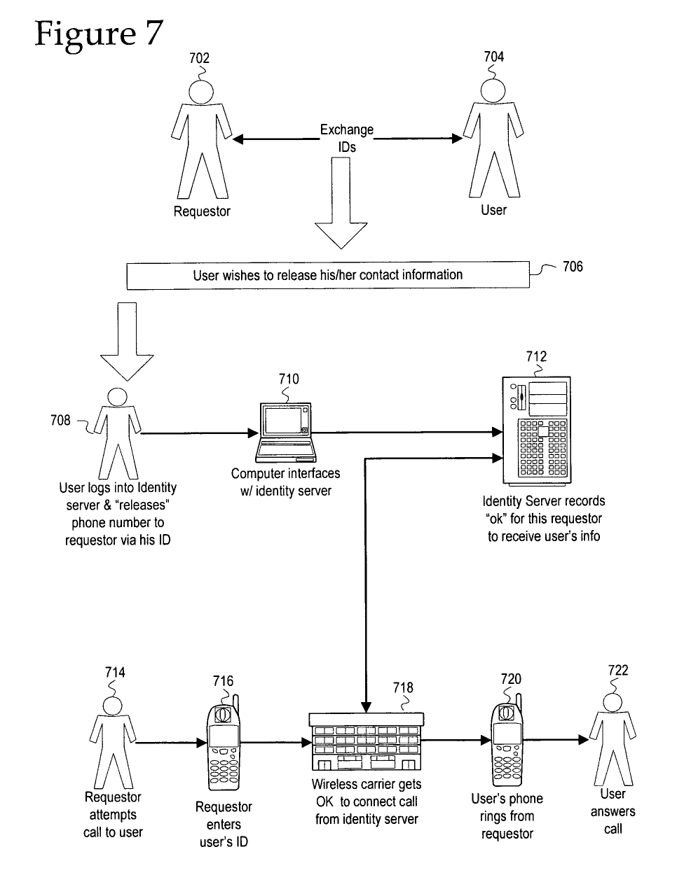

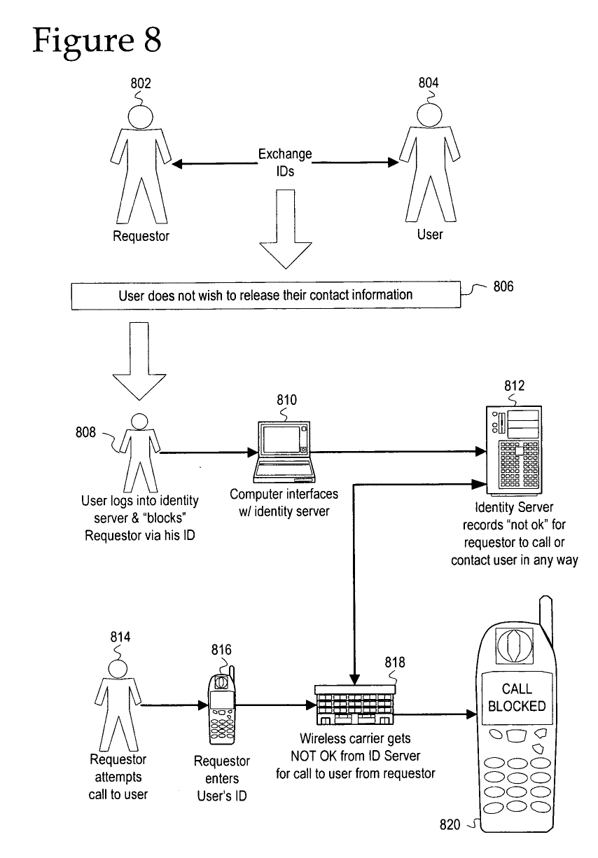

FIGS. 7 and 8 are diagrams of embodiments illustrating exemplary uses of an ID. In particular, FIG. 7 illustrates a user giving access to another user and FIG. 8 illustrates a user restricting access from another user. In FIG. 7, a requestor 702 exchanges IDs with a user 704. The user 704 wishes to release his/her contact information to the requestor as in block 706. The user 704 may modify his/her access restrictions and add the requestor's ID as someone who may get access to the user's ID. Accordingly, the user may log into the ID server and “release” his/her phone number to the requestor as in 708. The computer 710 interfaces with the ID server 712 such that the ID server or the ID database records that the requestor may access the user's phone number.

When the requestor attempts a call to the user as in 714, the requester enters the user's ID into his/her phone 716. The wireless carrier 718 receives the requested phone call with the user's ID and connects with the ID server 712 to retrieve the user's phone number. Because the user recorded that it is okay for the requestor to receive the phone number, the ID server returns the phone number to the wireless carrier. The wireless carrier 718 connects to the user's phone 720 which rings with a call from the requestor and the user 722 may answer the call. Accordingly, because the user granted access to the user, the requestor was able to call the user by dialing the user's ID and allowing the phone number to be retrieved from the ID server.

FIG. 8 illustrates a user restricting access from a requestor. A requestor 802 may exchange IDs with a user 804. In block 806, the user decides not to release his/her contact information. For example, a girl who meets a boy at a bar may exchange IDs, but then decide she does not want him to have access to her contact information. Accordingly, the user 808 uses her laptop 810 to log into the ID server 812 and “block” the requestor's ID from getting access to her contact information. The ID server or ID database records that the requestor (through his ID) cannot retrieve the user's contact information.

When the requestor 814 attempts a call with his phone 816 by entering the user's ID, the wireless carrier 818 connects to the ID server 812 to ask for the user's phone number. The ID server 812 knows that the requestor is not allowed access to the user's contact information, so the ID server 812 tells the wireless carrier 818 that it cannot receive the user's phone number. Accordingly, in block 820 the call is blocked.

Referring to FIG. 9, an illustrative embodiment of a general computer system is shown and is designated 900. The computer system 900 can include a set of instructions that can be executed to cause the computer system 900 to perform any one or more of the methods or computer based functions disclosed herein. The computer system 900 may operate as a standalone device or may be connected, e.g., using a network, to other computer systems or peripheral devices. Any of the components discussed above, including, but not limited to the ID server 102, the ID database 104, and/or the user device 108 may be a computer system 900 or a component in the computer system 900.

In a networked deployment, the computer system may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 904 includes a cache or random access memory for the processor 902. In alternative embodiments, the memory 904 is separate from the processor 902, such as a cache memory of a processor, the system memory, or other memory. The memory 904 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 904 is operable to store instructions executable by the processor 902. The functions, acts or tasks illustrated in the figures or described herein may be performed by the programmed processor 902 executing the instructions stored in the memory 904. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 916 configured to allow a user to interact with any of the components of system 900. The input device 916 may be a number pad, a keyboard, or a cursor control device, such as a mouse, or a joystick, touch screen display, remote control or any other device operative to interact with the system 900.

In a particular embodiment, as depicted in FIG. 9, the computer system 900 may also include a disk or optical drive unit 906. The disk drive unit 906 may include a computer-readable medium 910 in which one or more sets of instructions 912, e.g. software, can be embedded. Further, the instructions 912 may embody one or more of the methods or logic as described herein. In a particular embodiment, the instructions 912 may reside completely, or at least partially, within the memory 904 and/or within the processor 902 during execution by the computer system 900. The memory 904 and the processor 902 also may include computer-readable media as discussed above.

The present disclosure contemplates a computer-readable medium that includes instructions 912 or receives and executes instructions 912 responsive to a propagated signal, so that a device connected to a network 920 can communicate voice, video, audio, images or any other data over the network 920. Further, the instructions 912 may be transmitted or received over the network 920 via a communication port 918. The communication port 918 may be a part of the processor 902 or may be a separate component. The communication port 918 may be created in software or may be a physical connection in hardware. The communication port 918 is configured to connect with a network 920, external media, the display 914, or any other components in system 900, or combinations thereof. The connection with the network 920 may be a physical connection, such as a wired Ethernet connection or may be established wirelessly as discussed below. Likewise, the additional connections with other components of the system 900 may be physical connections or may be established wirelessly.

The network 920 may include wired networks, wireless networks, or combinations thereof, and may be representative of network 106 in FIG. 1. The wireless network may be a cellular telephone network, an 802.11, 802.16, 802.20, or WiMax network. Further, the network 920 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A system utilizing a universal identifier (“ID”) comprising:
a network;
an identification (“ID”) server coupled with the network;
an identification (“ID”) database coupled with the ID server and configured to store a plurality of IDs and information associated with each of the plurality of IDs, wherein each of the plurality of IDs identifies at least one user, further wherein the information associated with the IDs comprises at least one of contact information, preferences, payment information, profile information, access information, or combinations thereof related to the at least one user;
wherein the ID server is configured to allow the at least one user to edit the information associated with their ID including determining who has access to the information.

2. The system of claim 1 further comprising a user device configured to communicate with the ID server through the network, wherein the user device is associated with one of the at least one user.

3. The system of claim 2 wherein the user device comprises at least one of a personal computer, telephone, mobile phone, VoIP phone, personal digital assistant (“PDA”), smart-phone, or combination thereof.

4. The system of claim 2 wherein the at least one user device is associated with one of a plurality of the IDs.

5. The system of claim 1 wherein the contact information comprises at least one of a phone number, a postal address, an email address, an instant messenger (“IM”) address, a pager number, or combination thereof.

6. The system of claim 1 wherein preferences comprises at least one of past purchases, food delivery preferences, hotel preferences, airline/airplane preferences, or combinations thereof.

7. The system of claim 1 wherein payment information comprises at least one of a credit card, a bank account, a PAYPAL account, or a FIREPAY account.

8. The system of claim 1 wherein profile information comprises at least one of personal information, height, weight, clothes size, or combinations thereof.

9. The system of claim 1 wherein access information comprises at least one of individual access, group access, business access, security encryption, or combinations thereof.

10. The system of claim 9 wherein the access information establishes who has access to information associated with a particular ID.

11. A method for utilizing an identifier (“ID”) value comprising:
associating an ID with a user;
storing the ID and information from the user associated with the ID, wherein the information comprises access restrictions on how the information may be distributed;
receiving a request from a requestor for at least a portion of the information, the request including the ID associated with the information and identification of the at least a portion of the information that is requested; and
providing the at least a portion of the information upon verifying that the requestor is allowed access; based on the access restrictions associated with the ID.

12. The method of claim 11 wherein the information from the user associated with the ID comprises at least one of contact information, preferences, payment information, profile information, or access information.

13. The method of claim 1 1 further comprising receiving a request from the user to modify the information associated with the user's ID.

14. The method of claim 13 wherein the modification comprises at least one of allowing access to the requestor of selected information associated with the user's ID or denying access to the requester of selected information associated with the user's ID.

15. A method for utilizing a universal ID comprising:
storing a first ID for a first user, wherein the first ID is associated with information related to the first user;
storing a second ID for a second user, wherein the second ID is associated with information related to the second user;
receiving, from the first user, access requirements regarding availability of the information associated with the first ID;
receiving, from the second user, access requirements regarding availability of the information associated with the second ID;
allowing, to the second user, access to the information related to the first user based on receiving a request from the second user with the first ID if the access requirements allow access for the second user; and
allowing, to the first user, access to the information related to the second user based on receiving a request from the first user with the second ID if the access requirements allow access for the first user.

16. The method of claim 15 wherein the information related to the first user comprises at least one contact information, preferences, payment information, profile information, or access information related to the first user.

17. The method of claim 15 wherein the information related to the second user comprises contact information, preferences, payment information, profile information, or access information related to the second user.

18. The method of claim 15 the first ID for the first user and the second ID for the second user are stored in an ID database, which stores a plurality of IDs for a plurality of users.

19. In a computer readable storage medium having stored therein data representing instructions executable by a programmed processor for distributing information via a universal identifier (“ID”), the storage medium comprising instructions for:
storing a plurality of IDs, wherein each of the plurality of IDs identifies one of a plurality of users and includes information associated with the one of the plurality of users;
receiving a request for access to the information associated with one of the plurality of IDs from a requestor;
transmitting at least a portion of the information associated with one of the pluralities of IDs if access has been granted for the requestor;
wherein the information associated with the one of the plurality of users includes at least one of contact information, preferences, payment information, profile information, or access information.

20. The method of claim 19 wherein the access information in the information associated with the one of the plurality of users establishes if access is granted for the requestor.

21. A system for facilitating a communication between a requestor and a user with a media independent identifier associated with the user, the system comprising:
a network;
an identification (“ID”) server coupled with the network;
an identification (“ID”) database coupled with the ID server and configured to store the media independent identifier and information associated with the media independent identifier, wherein the information associated with the media independent identifier is available to a plurality of requestors.

22. The system of claim 21 wherein the information associated with the media independent identifier is transmitted to a requestor regardless of an identity of the requestor.

23. The system of claim 21 wherein the information associated with the media independent identifier is selected based on an identity of a requestor.

24. The system of claim 21 wherein a first vendor of the plurality of vendors can access the same information that a second vendor of the plurality of vendors can access.

25. The system of claim 21 wherein the plurality of vendors receives the information associated with the media independent identifier after requesting the information from the ID server.

26. The system of claim 21 wherein the information associated with the media independent identifier that is available to the plurality of vendors depends on the access restrictions established for the information.

27. The system of claim 21 wherein the ID server is configured to allow the at least one user to edit the information associated with their ID including determining who has access to the information.

28. A method for facilitating communication between first and second entities comprising:
providing a media independent identifier of the second entity to the first entity;
receiving a request to communicate with the second entity from the first entity, the request comprising the media independent identifier of the second entity;
determining a particular medium over which to facilitate the communication;
associating the media independent identifier of the second entity with a medium specific identifier of the second entity specific to the particular medium determined; and
facilitating communication with the second entity via the particular medium requested based on the medium specific identifier.

29. The method of claim 28, wherein the facilitating further comprises facilitating communication between the first entity and the second entity.

30. The method of claim 28, wherein the facilitating further comprises concealing the medium specific identifier from the first entity.

31. The method of claim 30, further comprising providing information about the second entity to the first entity.

32. The method of claim 28, wherein the particular medium comprises one of telephone, electronic mail, instant message, text message, voice message, facsimile, postal mail, overnight carrier, or combinations thereof.

33. The method of claim 28, wherein the request further comprises a specification of the particular medium of communication, the determining being based thereon.

34. The method of claim 28, wherein the determining further comprises inferring the particular medium as the most appropriate medium to use based on the request.

35. The method of claim 28, wherein the first entity comprises an intermediary facilitating communications between a third entity and the second entity.

36. The method of claim 35, wherein the facilitating further comprises concealing the medium specific identifier from the third entity.
